(19) United States
(12) Patent Application Publication
(10) Pub. No.: US 2012/0102763 A1
(43) Pub. Date: May 3, 2012

(54) Metal Shear Head Center Blade

(75) Inventor: Alexander Rozumovich, Loveland, OH (US)

(73) Assignee: KETT TOOL COMPANY, Cincinnati, OH (US)

(21) Appl. No.: 13/281,692

(22) Filed: Oct. 26, 2011

Related U.S. Application Data
(60) Provisional application No. 61/407,590, filed on Oct. 28, 2010.

(51) Int. Cl. B26B 13/06

(52) U.S. Cl. 30/357

(57) ABSTRACT

An improved longer life center blade for use in an existing metal cutting shear, by providing a center blade with a unique yoke profile, a reinforced bottom and a larger grind transition location.

### CROSS REFERENCE TO RELATED APPLICATIONS

This application claims the benefit of U.S. provisional Patent Application No. 61/407,590, which is fully incorporated by reference herein.

### FIELD OF THE INVENTION

The present invention relates to cutting devices in general and, more particularly, to handheld metal cutting shears.

### BACKGROUND OF THE INVENTION

It is common for a workman who needs to cut 14 to 18 gauge cold rolled mild steel or most grades of stainless steel up to 16 gauge, to use a handheld lightweight variable-speed pistol-grip electric shear, such as the KD-440, KM-440, or P-540 models available from the Kett Tool Company, 5055 Madison Road, Cincinnati, Ohio, or a variable-speed straight handle pneumatic shear, such as the P-1040 model also available from the Kett Tool Company.

More specifically, the KD-440 and KM-440 models are lightweight, variable-speed pistol-grip shears that cut up to 14 gauge cold rolled mild steel and most grades of stainless up to 16 gauge. They are double-insulated, with a 5-6.5 AMP motor that cuts at over 150 inches per minute, leaving a clean, flat sheet, ready to fabricate. Distortions are absorbed in an easily disposed of waste curl, leaving the sheet cool and free of burn, chips and burrs. The cutting blades are made from the finest high-speed steel, which can be easily replaced.

The P-540 model cuts up to 14 gauge in cold rolled steel. Its variable-speed trigger provides for smooth, easy starting cuts, even in most grades of stainless up to 16 gauge. It has a 4 pound, pistol-grip, 2200 RPM pneumatic motor, and runs on a 90 PSI power source. It is a great time-saver in any construction company, sheet metal or sign shop.

The P-1040 model has a variable speed trigger on a straight handle pneumatic shear, which provides for smooth, easy starting cuts in cold rolled mild steel up to 14 gauge and most grades of stainless up to 16 gauge. It leaves a 7/32″ waste curl which provides for straight cuts on both sides with no need to file or de-burr. It weighs about 4 pounds and is about 10″ long, making it lightweight and portable. It features the KETT 2500 RPM power unit designed for maximum efficiency at 90 PSI air pressure.

Each of these tools uses a Model 40-20 14 gauge steel shear head. This shear head is further comprised of a shear housing (Part No. 40-23), which holds three cutter blades, namely, a left side knife (Part No. 60-22L), a right side knife (Part No. 60-22R), and a center blade (Part No. 40-21). The shear housing also contains other components, such as an eccentric bearing assembly (Part No. 40-24), a couple of spacer bushings (Part Nos. 40-27 and 60-27), three cap screws (Part No. 92-28), three knurled inserts (Part No. 92-31), and a large thin washer (Part No. 60-25).

To remove or disassemble the shear head from the motor, a workman may loosen the three cap screws (Part No. 92-28). Next, he may remove the shear head from the motor by pulling the head firmly forward. A slight tapping with a mallet may be required if the head does not slide off easily.

To remove cutter blades from shear head, a workman may remove the three cap screws (Part No. 92-28) from shear housing (Part No. 40-23). It is important at this stage to be careful not to lose rear spacer bushing (Part No. 60-27) when removing the middle cap screw. The center blade (Part No. 40-21) may be removed from shear housing (Part No. 40-23) by tapping the blade gently rearward. Here, it is important to be careful not to lose spacer bushing (Part No. 40-27) from the hole in center blade. The side knives (Part Nos. 60-22L and 60-22R) will then drop out of the shear housing.

To remove the eccentric bearing assembly (Part No. 40-24) from the shaft, an appropriate wrench may be used to loosen eccentric nut by turning it counterclockwise.

To assemble or install the eccentric bearing assembly (Part No. 40-24) onto the shaft, it is important to first make sure the large thin washer (Part No. 60-25) is first inserted over the shaft. The eccentric bearing assembly may be screwed onto the shaft and tightened with an appropriate wrench. It is useful to also lubricate the bearing with a good grade of bearing grease.

To install cutter blades into shear housing (Part No. 40-23), a workman may place the side knives (Part Nos. 60-22L and 60-22R) into position in the shear housing (Part No. 40-23). The center cap screw (Part No. 92-28) may be inserted through the side knives (Part Nos. 60-22L and 60-22R) with the rear spacer bushing (Part No. 60-27) between them while starting a cap screw (Part No. 92-28) into thread just enough to hold blades in place. It is important at this stage to not tighten the cap screw, however. Next, the spacer bushing (Part No. 40-27) may be inserted into a hole in center blade (Part No. 40-21) and lubricated with Molybdenum Disulfide grease (Part No. 264-2) or equivalent. The center blade (Part No. 40-21) may next be installed into the shear housing (Part No. 40-23) by tapping blade gently forward using a drift to line up hole in center blade (Part No. 40-21) with the forward holes in housing. A cap screw (Part No. 92-28) is then inserted and tightened forward, making sure the spacer bushing (Part No. 40-27) in the center blade (Part No. 40-21) stays in position. Molybdenum Disulfide grease (Part No. 264-2) or equivalent should then be applied to the clevis or yoke in the center blade (Part No. 40-21) where it rides on the eccentric bearing assembly. Finally, the rear cap screw (Part No. 92-28) may be inserted into shear housing (Part No. 40-23), but should not be completely tightened.

To install shear head assembly onto drive motor, a workman should make sure all cap screws (Part No. 92-28) are loosened about three or four complete turns. The shear housing (Part No. 40-23) may be spread slightly using a spreader (drift) near the rear cap screw (Part No. 92-28). The shear head may be placed onto the unit, and the left side knife may be tapped rearward as far as it will go, and then the cap screws may be tightened to about 40-45 inch pounds. It may be necessary to gently tap the shear head into place if it does not readily slip onto the nose of the power unit.

Therefore, as one skilled in the art can appreciate, it is not advantageous to the efficiency of a workman to have to disassemble and then reassemble the shear head unit to, for example, replace a cutting blade, such as a center blade.

It is therefore an object of the invention to provide for a center blade that has a longer usable life, is less prone to breakage, whereby the time and expense in terms of parts, labor, and lost job time, may be minimized as compared to what is currently known in the art.

### SUMMARY OF THE INVENTION

An improved longer life center blade is provided for use in an existing metal cutting shear, by providing a center blade with a unique yoke profile, a reinforced bottom and a larger grind transition location.

According to one aspect of the invention, the center blade for a handheld metal cutting shear comprises a top edge spaced opposite a bottom edge, the top edge and the bottom edge connecting at a nose at one end and forming a yoke at the opposite end. The center blade further comprises a pivot hole positioned between the top edge and the opposite bottom edge and between the nose at one end and the yoke at the opposite end. The center blade further comprises a mechanical stress rising point defined by the intersection of a grind transition line with the top edge, wherein the mechanical stress rising point is positioned between about 0.704 to 0.804 inches from the center of the pivot hole.

According to another aspect of the invention, the center blade for a handheld metal cutting shear comprises a top edge spaced opposite a bottom edge, the top edge and the bottom edge connecting at a nose at one end and forming a yoke at the opposite end. The center blade further comprises a pivot hole positioned between the top edge and the opposite bottom edge and between the nose at one end and the yoke at the opposite end. The center blade further comprises a mechanical stress rising point defined by the intersection of a grind transition line with the top edge. The center blade further comprises the mechanical stress rising point providing the starting point of a break plane wherein the break plane has a height of between about 0.553 to 0.614 inches.

According to another aspect of the invention, the center blade for a handheld metal cutting shear comprises a top edge spaced opposite a bottom edge, the top edge and the bottom edge connecting at a nose at one end and forming a yoke at the opposite end. The center blade further comprises a pivot hole positioned between the top edge and the opposite bottom edge and between the nose at one end and the yoke at the opposite end. The center blade further comprises a mechanical stress rising point defined by the intersection of a grind transition line with the top edge. The mechanical stress rising point provides the starting point of a break plane wherein the break plane has a cross-sectional area of between about 0.076 to 0.085 square inches.

According to another aspect of the invention, the center blade for a handheld metal cutting shear comprises a top edge spaced opposite a bottom edge, the top edge and the bottom edge connecting at a nose at one end and forming a yoke at the opposite end. The center blade further comprises a pivot hole positioned between the top edge and the opposite bottom edge and between the nose at one end and the yoke at the opposite end. The center blade further comprises a cutting edge positioned along the top edge between the nose and the yoke, and between first clearance grind plane on a first side of the blade and a second clearance grind plane on a second side of the blade. The first side of the blade has a first draft angle disposed below the first clearance grind plane and a forward portion of the bottom edge and a second draft angle disposed below the second clearance grind plane and the forward portion of the bottom edge wherein the first and second draft angles are between about 9.5 to 10.5 degrees.

According to another aspect of the invention, the center blade for a handheld metal cutting shear comprises a top edge spaced opposite a bottom edge, the top edge and the bottom edge connecting at a nose at one end and forming a yoke at the opposite end. The center blade further comprises a pivot hole positioned between the top edge and the opposite bottom edge and between the nose at one end and the yoke at the opposite end. The center blade further comprises a cutting edge positioned along the top edge between the nose and the yoke, the cutting edge being displaced from a forward portion of the bottom edge by about 0.450 to 0.49 inches.

According to another aspect of the invention, the center blade for a handheld metal cutting shear comprises a top edge spaced opposite a bottom edge, the top edge and the bottom edge connecting at a nose at one end and forming a yoke at the opposite end. The center blade further comprises a pivot hole positioned between the top edge and the opposite bottom edge and between the nose at one end and the yoke at the opposite end. The center blade further comprises a cutting edge positioned along the top edge between the nose and the yoke, and between first clearance grind plane on a first side of the blade and a second clearance grind plane on a second side of the blade. The first and second sides converge at a forward portion of the bottom edge and the forward portion of the bottom edge has a width at the bottom of the blade of about 0.010 to 0.015 inches.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a side view of a prior art center blade;

FIG. 1A is a front view between the lines identified as 1A-1A of the prior art center blade shown in FIG. 1;

FIG. 2 is a side view of one embodiment of a center blade of the present invention; and

FIG. 2A is a front view between the lines identified as 2A-2A of the center blade shown in FIG. 2;

### DETAILED DESCRIPTION OF THE INVENTION

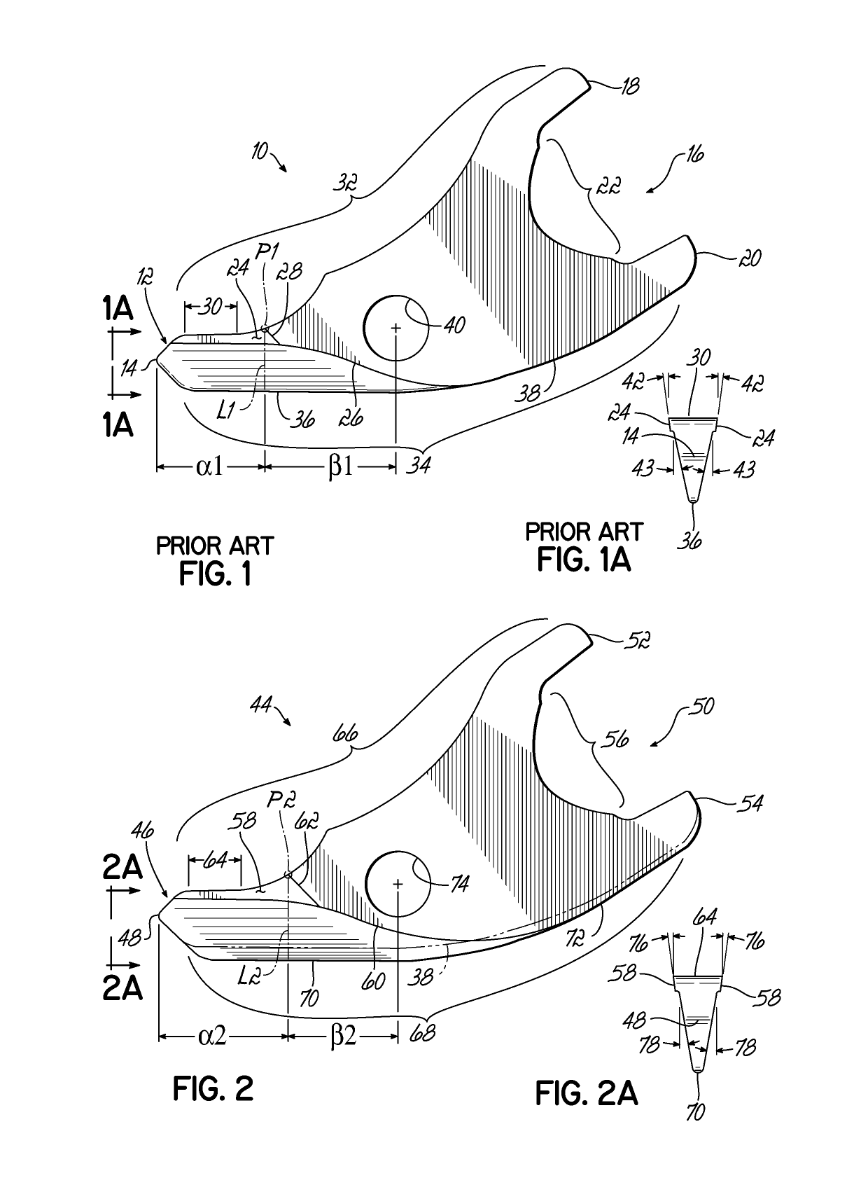

FIG. 1 illustrates one embodiment of a prior art center blade 10. As illustrated, the center blade 10 is formed in such a way so as to have a nose 12 with a tip 14 at one end and a yoke 16 at the other end. The yoke 16 is comprised of an upper yoke arm 18 and a lower yoke arm 20 which are separated by a concave portion 22 which is adapted to allow an eccentric bearing assembly (not shown) to move freely therein. The yoke 16 has a thickness of between about 0.209 to 0.211 inches.

The center blade 10 has a pair of opposite clearance grind planes 24 which are defined by a draft angle transition line 26 and a grind transition line 28. Connecting each of the clearance grind planes 24 is a generally flat portion or cutting edge 30 which is a forward portion of a top edge 32 of the center blade 10. The cutting edge 30 has a width of between about 0.2005 to 0.2045 inches, and preferably 0.2025 inches. When measured at the center of the cutting edge 30, the clearance grind planes 24 have a height of about 0.062 inches.

The center blade 10 has a bottom edge 34 positioned opposite the top edge 32. The bottom edge 34 has a forward portion 36 which is separated from an aft portion 38 by the draft angle transition line 26.

The center blade 10 is attached to the shear head (not shown) via a pivot hole 40 which allows the center blade 10 to operationally pivot or oscillate, whereby a cutting motion is effectuated.

As shown in FIG. 1A, the prior art center blade 10 has symmetrical clearance grind angles 42 of 7.5 degrees and symmetrical draft angles 43 of 12.5 degrees. The radius of the forward portion 36 of the bottom edge 34 in a 14 gauge shear was historically about 0.020 inches.

The intersection of the grind transition line 28 with the ground top edge 32 results in forming a mechanical stress rising point P1. In a 14 gauge shear, the mechanical stress rising point P1 was historically placed at a distance α1 of about 0.750 inches from the nose tip 14 and a distance β1 of about 0.910 inches from the center of the pivot hole 40. Due to high cutting loads, an initial metal crack may propagate from this point P1 down towards the forward portion 36 of the bottom edge 34. The blade 10 may then break completely along the break plane L1. In a 14 gauge shear, the break plane L1 historically had a height of about 0.414 inches, whereas the height at the cutting cross-section, i.e., the distance between the cutting edge 30 and the forward portion 36 of the bottom edge 34 was about 0.380 inches. The resistance of the blade 10 to breakage is determined by a cross-section area defined by the break plane L1. In a 14 gauge shear, this grind transition cross-section area (breakage area) was historically about 0.051 square inches.

An embodiment of the present invention is shown in FIGS. 2 and 2A. More specifically, the center blade 44 is formed in such a way so as to have a nose 46 with a tip 48 at one end and a yoke 50 at the other end. The yoke 50 is comprised of an upper yoke arm 52 and a lower yoke arm 54 which are separated by a concave portion 56 which is adapted to allow an eccentric bearing assembly (not shown) to move freely therein. The yoke 50 has a thickness of between about 0.209 to 0.211 inches.

The center blade 44 has a pair of opposite clearance grind planes 58 which are defined by a draft angle transition line 60 and a grind transition line 62. Connecting each of the clearance grind planes 58 is a generally flat portion or cutting edge 64 which is a forward portion of a top edge 66 of the center blade 44. The cutting edge 64 has a width of between about 0.2005 to 0.2045 inches, and preferably 0.2025 inches. When measured at the center of the cutting edge 64, the clearance grind planes 58 have a height of about 0.062 inches.

The center blade 44 has a bottom edge 68 positioned opposite the top edge 66. The bottom edge 68 has a forward portion 70 which is separated from an aft portion 72 by the draft angle transition line 60.

The center blade 44 is attached to the shear head (not shown) via a pivot hole 74 which allows the center blade 44 to operationally pivot or oscillate, whereby a cutting motion is effectuated.

As shown in FIG. 2A, the center blade 44 has symmetrical clearance grind angles 76 of between about 7 to 8 degrees, and preferably, 7.5 degrees and symmetrical draft angles 78 of between about 9.5 to 10.5 degrees and, preferably, 10 degrees. The draft angles 76 are inwardly recessed from the clearance grind planes 24 by about 0.007 to 0.011 inches. The radius of the forward portion 70 of the bottom edge 68 in this embodiment is between 0.010 to 0.015 inches and, preferably, 0.012 inches.

The intersection of the grind transition line 62 with the ground top edge 66 results in forming a mechanical stress rising point P2. In this embodiment, this mechanical stress rising point P2 is positioned at a distance α2 of between about 0.850 to 0.950 inches and, preferably, 0.900 inches from the nose tip 48 and at a distance β2 of between about 0.704 to 0.804 inches and, preferably, 0.754 inches from the center of the pivot hole 74. Due to high cutting loads, an initial metal crack may propagate from this point P2 down towards the forward portion 70 of the bottom edge 68. The blade 44 may then break completely along the break plane L2. In this embodiment, the break plane L2 has a height of between about 0.553 to 0.614 inches and, preferably, 0.580 inches, and the height at the cutting cross-section, i.e., the distance between the cutting edge 64 and the forward portion 70 of the bottom edge 68 is between about 0.450 to 0.490 inches, or 0.478 to 0.482 inches and, preferably, 0.480 inches. The resistance of the blade 44 to breakage is determined by the cross-section area defined by break plane L2. In this embodiment, grind transition cross-section area (breakage area) is between about 0.076 to 0.085 square inches and, preferably, about 0.080 square inches.

As compared with the prior art, the center blade 44 of the present invention has achieved unique strength and endurance properties. More specifically, by increasing the area of the break plane L2, by moving the grind transition line 62 closer to the pivot hole 74, and moving the stress point P2 higher up along the curved part of the top edge 66, the center blade 44 has been found to be less prone to breakage. This is due to the fact that the stress point P2, i.e., the point where the grind transition line 62 intersects with the top edge 66, acts as a stress riser and a fraction will start there and propagate almost straight downward along L2. Hence, the larger the cross section area is along L2, the smaller the stress (i.e., pressure units lbs/sq. in.) that will be imposed to the blade 44 and thus, the less chance of breakage. The stress and the likelihood of breakage are inversely proportional to that cross-sectional area.

Similarly, by altering the draft angle 78, which in turn provides for additional cross-section area of the break plane L2 and reinforcement to the bottom edge 68, particularly in the forward portion 70 thereof, has also been found to increase the resiliency of the center blade 44 and make it less prone to traditional breakage. Compared to the prior art, which had a cross-sectional area of about 0.051 sq. inches, the embodiment shown in FIGS. 2 and 2A, has a cross-sectional area of 0.080 sq. inches, which is an increase of about 56%, and as such, about equally stronger. While the present invention includes more metal in the forward portion 70 of the bottom edge 68, there is nevertheless additional metal and reinforcing all along the aft portion 72 thereof as well, including the lower yoke arm 54, which sometimes is also prone to traditional breakage.

While the present invention has been illustrated by description of various embodiments and while these embodiments have been described in considerable detail, it is not the intention of the applicant to restrict or in any way limit the scope of the claims to such detail. Additional advantages and modifications will readily appear to those skilled in the art. The invention in its broader aspect is, therefore, not limited to the specific details, representative system, apparatus, and method, and illustrative example shown and described. Accordingly, departures may be made from such details without departing from the spirit or scope of the applicant's general inventive concept.

What is claimed is:

1. A center blade for a handheld metal cutting shear comprising:
a top edge spaced opposite a bottom edge, the top edge and the bottom edge connecting at a nose at one end and forming a yoke at the opposite end;
a pivot hole positioned between the top edge and the opposite bottom edge and between the nose at one end and the yoke at the opposite end;
a mechanical stress rising point defined by the intersection of a grind transition line with the top edge;
wherein the mechanical stress rising point is positioned between about 0.704 to 0.804 inches from the center of the pivot hole.

2. A center blade for a handheld metal cutting shear comprising:
a top edge spaced opposite a bottom edge, the top edge and the bottom edge connecting at a nose at one end and forming a yoke at the opposite end;
a pivot hole positioned between the top edge and the opposite bottom edge and between the nose at one end and the yoke at the opposite end;
a mechanical stress rising point defined by the intersection of a grind transition line with the top edge;
the mechanical stress rising point providing the starting point of a break plane;
wherein the break plane has a height of between about 0.553 to 0.614 inches.

3. A center blade for a handheld metal cutting shear comprising:
a top edge spaced opposite a bottom edge, the top edge and the bottom edge connecting at a nose at one end and forming a yoke at the opposite end;
a pivot hole positioned between the top edge and the opposite bottom edge and between the nose at one end and the yoke at the opposite end;
a mechanical stress rising point defined by the intersection of a grind transition line with the top edge;
the mechanical stress rising point providing the starting point of a break plane;
wherein the break plane has a cross-sectional area of between about 0.076 to 0.085 square inches.

4. A center blade for a handheld metal cutting shear comprising:
a top edge spaced opposite a bottom edge, the top edge and the bottom edge connecting at a nose at one end and forming a yoke at the opposite end;
a pivot hole positioned between the top edge and the opposite bottom edge and between the nose at one end and the yoke at the opposite end;
a cutting edge positioned along the top edge between the nose and the yoke, and between first clearance grind plane on a first side of the blade and a second clearance grind plane on a second side of the blade;
wherein the first side of the blade has a first draft angle disposed below the first clearance grind plane and a forward portion of the bottom edge and a second draft angle disposed below the second clearance grind plane and the forward portion of the bottom edge;
wherein the first and second draft angles are between about 9.5 to 10.5 degrees.

5. A center blade for a handheld metal cutting shear comprising:
a top edge spaced opposite a bottom edge, the top edge and the bottom edge connecting at a nose at one end and forming a yoke at the opposite end;
a pivot hole positioned between the top edge and the opposite bottom edge and between the nose at one end and the yoke at the opposite end; and
a cutting edge positioned along the top edge between the nose and the yoke, the cutting edge being displaced from a forward portion of the bottom edge by about 0.450 to 0.490 inches.

6. A center blade for a handheld metal cutting shear comprising:
a top edge spaced opposite a bottom edge, the top edge and the bottom edge connecting at a nose at one end and forming a yoke at the opposite end;
a pivot hole positioned between the top edge and the opposite bottom edge and between the nose at one end and the yoke at the opposite end;
a cutting edge positioned along the top edge between the nose and the yoke, and between first clearance grind plane on a first side of the blade and a second clearance grind plane on a second side of the blade;
wherein the first and second sides converge at a forward portion of the bottom edge, and the forward portion of the bottom edge has a width at the bottom of the blade of about 0.010 to 0.015 inches.
